(19) United States
(12) Patent Application Publication
(10) Pub. No.: US 2005/0200230 A1
(43) Pub. Date: Sep. 15, 2005

(54) Electric motor with interference suppressor

(76) Inventors: Francois Breynaert, Caen (FR); Hermann Yvetot, Saint Denis De Mere (FR)

Correspondence Address: CARLSON, GASKEY & OLDS, P.C., 400 WEST MAPLE ROAD, SUITE 350, BIRMINGHAM, MI, 48009, US

(21) Appl. No.: 11/063,337

(22) Filed: Feb. 22, 2005

(30) Foreign Application Priority Data
Mar. 9, 2004 (FR) 04 02 439

(51) Int. Cl. H02K 13/06; H02K 13/10

(52) U.S. Cl. 310/222; 310/233

(57) ABSTRACT

An electric motor includes a commutator housing mounted integrally with a stator. The housing includes brushes and an interference suppressor filter that links the brushes pairwise. A commutator including a support ring is integrally mounted with a rotor shaft and has a plurality of metal segments arranged around a circumference of the support ring. A capacitor is connected between two adjacent metal commutator segments. Combining the two interference suppressor devices directly on the commutator and the commutator housing maximally reduces spurious signal emissions and satisifies the most stringent electromagnetic noise class requirements.

### REFERENCE TO RELATED APPLICATIONS

The present application claims the benefit of French Patent Application No. 04 02 439, filed Mar. 9, 2004.

### BACKGROUND OF THE INVENTION

This invention relates generally to an electric motor with an interference suppressor device. In particular, the invention relates to an electric motor designed to drive motor vehicle equipment, such as a window regulator, a sunroof or a seat operation motor.

An electric motor generally includes a stator frame and a rotor mounted rotatably in the stator frame. The motor also includes windings that are integral with the rotor shaft, and each winding is electrically connected to two diametrically opposed segments of a commutator. The commutator conventionally includes a ring having a series of conductive segments around its circumference, and the commutator ring is designed to be mounted integrally on a rotor shaft.

The commutator is generally mounted in a commutator housing that is integral with the stator. The commutator housing includes a housing support having a central opening designed to receive the commutator and to allow the rotor shaft to pass through the housing support. The housing support is made of an insulating material, for example a plastic material.

The commutator housing also includes at least one pair of brushes that are diametrically opposed relative to the commutator and designed to contact segments of the commutator during its rotation with the rotor shaft. The brushes are electrically connected to a supply of electric current.

When the motor is operating, as is known, the brushes are pressed against the commutator segments to successively supply the various windings corresponding to the various pairs of diametrically opposed segments with electric current while the commutator is rotating with the rotor.

Thus, when the motor is running, the brushes are successively in contact with the various rotating commutator segments. When a brush passes from one segment to the next, an electric arc can be generated between the brush and the segment which was previously in electrical contact with the brush. The creation of an electric arc is a known phenomenon when a switch is opened and when electric current is passing therethrough. In the present case, the electric arc is due to the inductive effect of the winding previously powered by the brush.

The appearance of electric arcs or voltage spikes created between the commutator segments and the brushes can, firstly, damage these elements and, secondly, be a source of spurious signals which can interfere with other equipment of the motor or the vehicle.

Further, standards on radio interference set limits on spurious signal propagation from one piece of equipment to another. Thus, the International Special Committee on Radio Interference (CISPR) or other bodies have defined various classes corresponding to different levels of interference. Depending on the vehicle range, vehicle manufacturers are obliged not to exceed set levels of electromagnetic interference.

To reduce induced spurious signals, filters are fitted to commutator housings. FIG. 1 illustrates a commutator housing 100 carrying a support 105 on which an interference suppressor filter 110 is arranged. The commutator housing 100 includes two brushes 120 designed to contact commutator segments, and a recess 130 receives the commutator to allow a rotor shaft to pass through the support 105 of the commutator housing 100.

The interference suppressor filter 110 is constituted by an LC (inductance-capacitance) type circuit linking the two supply brushes 120 of the commutator housing 100, making it possible to partially filter out the interference created by the two supply brushes 120 commutating on the commutator segments.

The LC filter does not make it possible to sufficiently filter out induced spurious signals. As a result, motors fitted with this device do not meet the highest radioelectric interference standards.

The graph in FIG. 3a shows radioelectric noise induced by the motor as a function of frequency. The graph is purely illustrative and the numerical values on the X and Y axes are typical values. For certain frequencies, this solution does not make it possible to meet the most stringent approval conditions.

French patent 2,814,868 discloses an electric motor commutator having a simplified interference suppressor device. Discharge circuits are provided on a printed circuit board of an annular shape sleeved onto the rotor shaft. Each pair of adjacent commutator segments is thus linked by an RC (resistance-capacitance) circuit of the printed circuit that is integral with the commutator ring. The discharge circuits make it possible to avoid most electric arc phenomena and limit voltage spikes.

Nevertheless, such an interference suppressor device requires the production and the mounting of a printed circuit. Further, to operate correctly, it is necessary to provide a presser member to permanently keep the printed circuit lands in contact with the commutator segments.

This prior art solution consequently leads to increased manufacturing costs and creates a risk of incorrect operation due to poor contact. Further, this solution is not able to satisfy the most stringent approval conditions.

There is consequently a need for a commutator housing that achieves a high degree of interference suppression while guaranteeing reliable mounting and operation.

### SUMMARY OF THE INVENTION

The invention provides an electric commutator motor including a commutator housing mounted integrally with a stator. The commutator housing includes at least two brushes that contact with a commutator and an interference suppressor filter linking the brushes pairwise. The commutator includes a support ring integrally mounted with a rotor shaft and a plurality of metal segments arranged around a circumference of the support ring. A capacitor is connected between two adjacent metal commutator segments.

Preferably, the capacitors are arranged between the support ring and the metal segments of the commutator. Each capacitor preferably carries two electrical terminals respectively soldered to one of two adjacent segments of the commutator. A plurality of capacitors can each be connected in parallel between a pair of adjacent metal segments of the commutator. The interference suppressor filter of the commutator housing preferably includes at least one coil and at least one capacitor.

Further features and advantages of the invention will become more clear from the detailed description that follows of some embodiments of the invention given solely by way of example and with reference to the attached drawings.

### BRIEF DESCRIPTION OF THE DRAWINGS

FIG. 1 is a diagram of a commutator housing according to the prior art;

FIG. 2 is a diagram of a commutator employed in an electric motor according to the invention;

FIG. 3a is a graph illustrating radioelectric noise levels as a function of frequency for the commutator housing of FIG. 1;

FIG. 3b is a graph showing radioelectric noise levels as a function of frequency for the commutator of FIG. 2; and

FIG. 3c shows radioelectric noise levels as a function of frequency for an electric motor according to the invention.

### DETAILED DESCRIPTION OF PREFERRED EMBODIMENTS

The motor according to the invention includes a commutator housing fitted with an interference suppressor filter and a commutator that includes an interference suppressor device mounted on the commutator housing.

The commutator housing is mounted integral with a stator and includes at least two brushes that contact the commutator and an interference suppressor filter linking the at least two brushes pairwise.

Further, the commutator includes a support ring integrally mounted with a rotor shaft, a plurality of metal segments arranged around a circumference of the support ring, and a plurality of capacitors arranged between the support ring and the metal segments. Each capacitor is connected between two adjacent metal segments. The capacitors connected between each metal segment provide a good discharge of electric arcs generated.

Additionally, the commutator is mounted on the commutator housing carrying the interference suppressor filter which supplements the filtering function of the capacitors arranged on the commutator.

The combination of these two interference suppressor devices, directly on the commutator and on the commutator housing, provides maximum spurious signal emission reduction and satisfies the highest noise class requirements known.

The commutator employed in the electric motor according to the invention will now be described with reference to FIG. 2. The commutator 10 includes a support ring 11, generally made of a plastic material, and a plurality of metals segments 12 arranged around a circumference of the support ring 11. The metal segments 12 are generally arranged in notches of the support ring 11 and are thereby insulated from each other by plastic ribs 14. The metals segments 12 also include hook members 13 machined at one end of each metal segment 12. The hook members 13 allow subsequent connection of the commutator metal segments 12 to the rotor windings.

Capacitors 20 are arranged directly between the support ring 11 and the commutator metal segments 12. Each capacitor 20 includes two electric terminals 21 and 22 respectively soldered to one of two adjacent metal segments 12. A plurality of capacitors 20 are arranged in the commutator 10 employed in the invention, and each capacitor 20 is connected between two adjacent metal segments 12.

The capacitors 20 employed are of the SMD (surface mount device) type, which offers a compact and inexpensive solution. The capacitors 20 can have a small value of around 470 nF, for example. Such components are readily available on the market at a low cost.

In one application, the plurality of capacitors 20 can be arranged in parallel and each soldered onto a pair of adjacent metal segments 12. This makes it possible to increase discharge capacity between the commutator metal segments 12 while still using low-value capacitors.

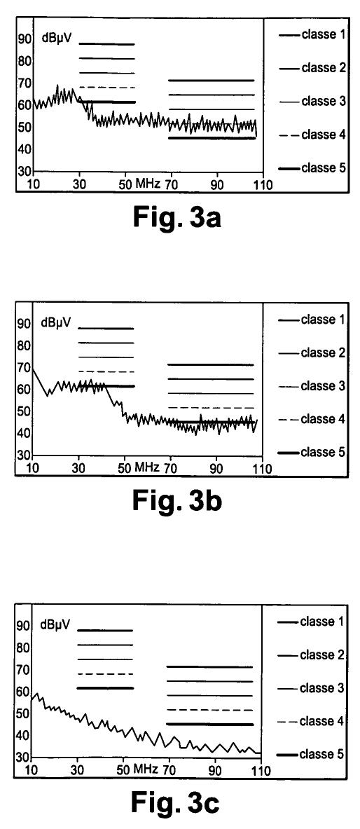

The graph in FIG. 3b shows radioelectric noise induced by a motor that includes the commutator 10 of FIG. 2 as a function of frequency. The graph is also purely illustrative and the numerical values on the X and Y axes do not limit the invention. It will be noticed that when compared to the graph in FIG. 3a showing noise induced by a motor that includes a simple interference suppressor device on a commutator housing of the prior art, induced radioelectric noise reduces. Nevertheless, the most stringent approval conditions are still not satisfied.

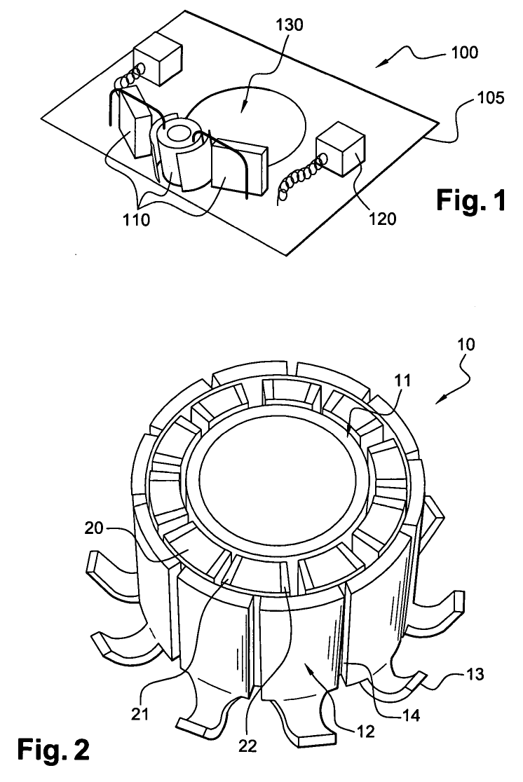

The commutator 10 of FIG. 2 is placed inside the commutator housing 100 as shown in FIG. 1 when an electric motor is being assembled. The commutator housing 100 is arranged in the stator of the electric motor (not shown, but known).

Assembly of the various parts can be performed as follows. The support ring 11 of the commutator 10 is slipped over a rotor shaft. The rotor shaft carries the usual windings. The windings are then each respectively connected to two diametrically opposite commutator metal segments 12. These connections with the rotor windings can employ the hook members 13 provided at the end of each metal segment 12.

The rotor shaft on which the support ring 11 has been slipped is placed in the stator and passes through the recess 130 in the commutator housing 100. The commutator 10, provided with the capacitors 20, is thus positioned on the support 105 of the commutator housing 100 that carries the interference suppressor filter 110.

The interference suppressor filter 110 (R-L-C) of any type can be employed in the framework of the invention. The interference suppressor filter 110 of the commutator housing 100 can optionally be simplified since the capacitors 20 of the commutator 10 already provide a relatively effective (see graph of FIG. 3b) interference suppression function.

The electric motor carries a commutator housing 100 mounted integrally with a stator that carries an interference suppressor filter. The commutator 10 is mounted integrally with the rotor shaft and also carries an interference suppressor device constituted by a plurality of capacitors connected between pairs of adjacent metal segments 12. The electric motor obtained thus includes an improved interference suppressor device.

The graph in FIG. 3c shows radioelectric noise induced by the motor of the invention. It will be noticed that, compared to the graphs of FIGS. 3a and 3b, induced radioelectric noise has been reduced. In particular, the most stringent approval conditions are satisfied for all frequencies.

Obviously, this invention is not limited to the embodiments described by way of example. Thus, the arrangement of the capacitors 20 on the commutator 10 and the arrangement of the interference suppressor filter 110 on the commutator housing 100 can be adapted to various models of electric motors.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. An electric motor comprising:
a commutator housing mounted integrally with a stator, the commutator housing including at least two brushes and an interference suppressor filter linking the at least two brushes; and
a commutator including a support ring having a circumference that is integrally mounted with a rotor shaft, a plurality of metal segments arranged around the circumference of the support ring, and a plurality of capacitors, wherein each of the plurality of capacitors is connected between two of the plurality of metal segments that are adjacent and wherein the at least two brushes contact the commutator.

2. The electric motor according to claim 1, wherein the plurality of capacitors are arranged between the support ring and the plurality of metal segments.

3. The electric motor according to claim 1, wherein each of the plurality of capacitors carries two electrical terminals each respectively soldered to one of the two of the plurality of metal segments that are adjacent.

4. The electric motor according to claim 1, wherein each of the plurality of capacitors are connected in parallel between the two of the plurality of metal segments that are adjacent.

5. The electric motor according to claim 1, wherein the interference suppressor filter of the commutator housing includes at least one coil and at least one capacitor.

6. The electric motor according to claim 2, wherein the interference suppressor filter of the commutator housing includes at least one coil and at least one capacitor.

7. The electric motor according to claim 3, wherein the interference suppressor filter of the commutator housing includes at least one coil and at least one capacitor.

8. The electric motor according to claim 4, wherein the interference suppressor filter of the commutator housing includes at least one coil and at least one capacitor.
